(19) United States
(12) Patent Application Publication
(10) Pub. No.: US 2011/0011342 A1
(43) Pub. Date: Jan. 20, 2011

(54) Cricket Box

(75) Inventors: John Williams, St. Louis, MO (US); Clay A. Ghann, Augusta, GA (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: MENASHA CORPORATION, Neenah, WI (US)

(21) Appl. No.: 12/765,276

(22) Filed: Apr. 22, 2010

Related U.S. Application Data
(60) Provisional application No. 61/171,621, filed on Apr. 22, 2009.

(51) Int. Cl. A01K 29/00; A01K 1/00

(52) U.S. Cl. 119/6.5; 119/496; 229/120.1

(57) ABSTRACT

A cricket box formed from a foldable blank of material, such as paperboard. The cricket box includes a first side panel with a window allowing for visible inspection of any crickets in the box. The box further includes a top panel, a second side panel, a bottom panel, and a partition panel. The partition panel is folded into the interior of the box to provide a crawl space for the crickets. The partition panel is provided with a plurality of perforations and a plurality of holes to allow the crickets to crawl around the panel.

### CROSS-REFERENCE TO RELATED APPLICATIONS

The present application claims the benefit of U.S. Provisional Patent Application No. 61/171,621 filed Apr. 22, 2009, the contents of which are incorporated herein by reference.

### FEDERALLY SPONSORED RESEARCH OR DEVELOPMENT

N/A

### FIELD OF THE INVENTION

The present invention generally relates to a box for displaying and transporting live insects such as crickets; and more particularly, to a box formed primarily from folded paperboard that provides the insects with a crawlspace and includes a window for visible inspection of the insect cargo by a customer.

### BACKGROUND OF THE INVENTION

A variety of containers are used for selling and transporting live insects. Many such containers are expensive to produce, and/or provide undue stress on the insects. In many instances, it is necessary for the insects to be in a healthy condition after transport in the container.

The present invention provides an easily constructed, low cost box for displaying and shipping live crickets or other insects that overcomes the problems of prior insect containers.

### SUMMARY OF THE INVENTION

The present invention provides a cricket box that is easily constructed from a foldable paper material. While the box is preferably used for crickets, it may be used to hold and transport other insects.

The box includes an integrally formed panel which is folded into the interior of the box to provide a crawlspace for the insects. Additionally, the box includes a window covered by cellophane to allow visible inspection of the insects.

In accordance with one embodiment of the invention, an easily assembled cricket box comprises a first side panel including a window having a film of transparent or translucent material glued across the window. The box further includes a top panel integrally connected to the first side panel, a second side panel integrally connected to the top panel, a bottom panel integrally connected to the top panel, and an interior partition panel integrally connected to the bottom panel. A glue panel can be integrally connected to the first side panel and can be glued to the bottom panel.

The partition panel can include a plurality of perforations and/or a plurality of holes. Additionally, the partition panel can include a projection for supporting a food product and an opening generally aligned with the window.

In accordance with another aspect of the invention, a blank for forming a cricket box comprises a single, foldable paperboard piece having a first side panel, a second side panel, a top panel, a bottom panel, and a partition panel. The first side panel includes a window.

In accordance with another embodiment of the invention, an easily assembled cricket box comprises a first side panel including a window having a film of one of transparent and translucent material glued across the window, a second side panel, a top panel connected to the first side panel and second side panel, a bottom panel connected to the first side panel and second side panel, and an interior partition panel.

The partition panel can include a plurality of perforations and a plurality of holes which enhances the ability of the crickets to climb around the partition panel. Additionally, the partition panel can include a projection for supporting a food product. The partition panel can also include an opening generally aligned with the window and other large openings or cut-outs to enable crickets to move from one side of the panel to the other.

A glue panel can be integrally connected to the first side panel. The glue panel includes a layer of glue that is used to connect the glue panel to the bottom panel when setting up a box. The panel can be glued to all or a portion of the bottom panel, either on an interior surface or an exterior surface. Preferably, the glue panel is positioned to limit access to the glue by the crickets.

The first side panel, second side panel, top panel, bottom panel, partition panel and glue panel are preferably formed from a single, foldable paperboard piece or blank. In this embodiment, the first side panel can be integrally connected to the top panel on one side and integrally connected to the glue panel on a second side. Moreover, the bottom panel can be integrally connected on one side to the partition panel.

In accordance with another embodiment, a box for containing and transporting insects comprises a first side wall panel integrally connected to a top wall panel and a glue panel. The top wall panel is also integrally connected to a second side wall panel. Additionally the box includes a bottom wall panel integrally connected to the second side wall panel and integrally connected to a partition panel. The first side wall panel includes a window to allow for visible inspection of the crickets. The window can be covered with a transparent and translucent material glued or otherwise secured to the box. As assembled, the glue panel is glued to at least a portion of the bottom wall panel and the partition panel is positioned in an interior of the box. The first side wall panel, top wall panel, second side wall panel, bottom wall panel and partition panel can be formed from a single sheet or blank of paperboard.

The first side wall panel, the top wall panel, the second side wall panel and the bottom panel can each include a flap for forming an end closure at a first end of the box. Flaps or caps can be used to close the other end of the box.

In accordance with yet another embodiment of the invention, a box for containing a plurality of crickets comprises a paperboard sheet folded into a first side, a second side, a top side and a bottom side. One of the first side, second side, top side and bottom side includes a window for viewing the contents of an interior of the box. Additionally, a paperboard partition panel is positioned in the interior of the box to provide a crawlspace for crickets placed in the box.

Other features and advantages of the invention will be apparent from the following specification taken in conjunction with the following Figures.

### BRIEF DESCRIPTION OF THE FIGURES

To understand the present invention, it will now be described by way of example, with reference to the accompanying Figures in which:

FIG. 1 is a plan view of a blank of a box for holding live insects, such as crickets, in accordance with one embodiment of the present invention;

FIG. 2 is a plan view of a blank of an insect box in accordance with an alternative embodiment of the present invention;

FIG. 3 is a perspective view of a constructed insect box in accordance with the present invention;

FIG. 4 is a perspective view of a side of the insect box having a window;

FIG. 5 is a perspective view of the side of the insect box having a window;

FIG. 6 is a perspective view of an end of the box and the interior of the box;

FIG. 7 is a perspective view of the end of the box and the interior of the box;

FIG. 8 is a plan view of a blank for an insect box in accordance with another embodiment of the present invention; and,

FIG. 9 is a perspective view of a cap or top for use with the insect boxes of the present invention.

### DETAILED DESCRIPTION OF THE INVENTION

While this invention is susceptible of embodiments in many different forms, there is shown in the Figures and will herein be described in detail preferred embodiments of the invention with the understanding that the present disclosure is to be considered as an exemplification of the principles of the invention and is not intended to limit the broad aspect of the invention to the embodiments illustrated.

The present invention provides an easily constructed box for holding and transporting insects, such as crickets. The crickets are typically about ⅝ to ¾ inches in length. The box is preferably formed from a 22 point solid unbleached sulfate board. Alternatively, a clay coat news back recycled paperboard can be used or other similar materials can be used (however, in some trials, the crickets have eaten or attempted to eat through the news back recycled paperboard). A foldable blank is cut from the paperboard to create the box.

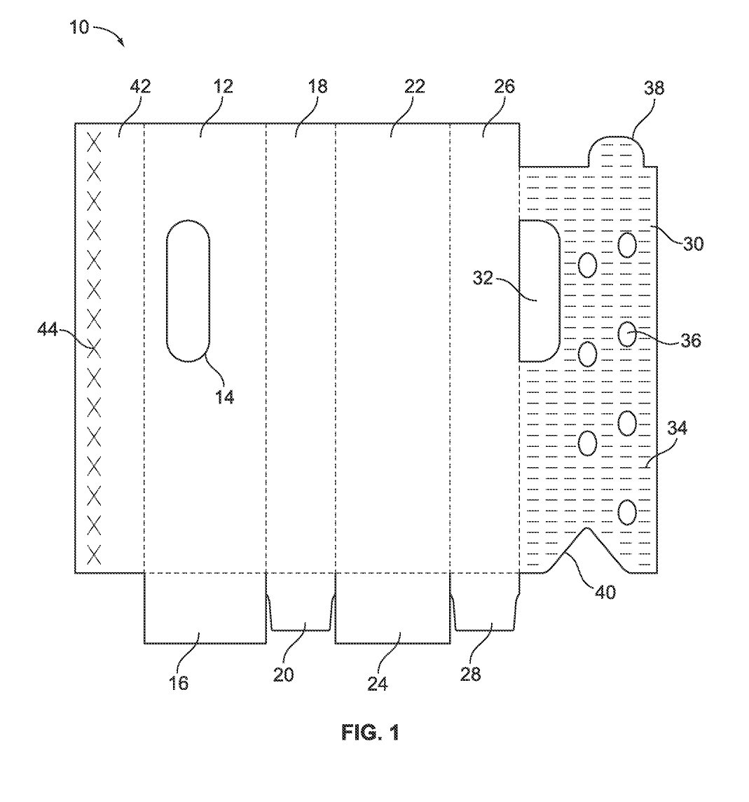

Referring to FIG. 1, a blank 10 of paperboard is shown which can be folded to form the cricket box. The blank 10 includes a first side panel 12. The first side panel 12 includes a window 14 cut out of the first side panel 12 to enable a customer to see the condition of any insects contained in the box 10. A clear or translucent film, such as a polypropylene or other similar material, can be used cover the window 14 (as discussed below). The film can be glued to the interior surface of the first side panel 12 of the box 10. An end flap 16 is integrally connected to an end of the first side panel 12.

The blank 10 further includes a top panel 18 connected at one side to one side of the first side panel 12. The top panel 18 also includes an end flap 20 extending from an end of the top panel 18. A second side wall 22 having an end flap 24 is connected at one side to the other side of the top panel 18, and a bottom wall 26 having an end flap 28 is connected to the other side of the second side wall 22. As described, first side, second side, top and bottom are simply used for reference and are not meant to limit the scope of the invention. When constructed, the outer surface of the box generally forms a rectangle with four sides, a closed end and an open end. A cap (described below) is fitted to the open end.

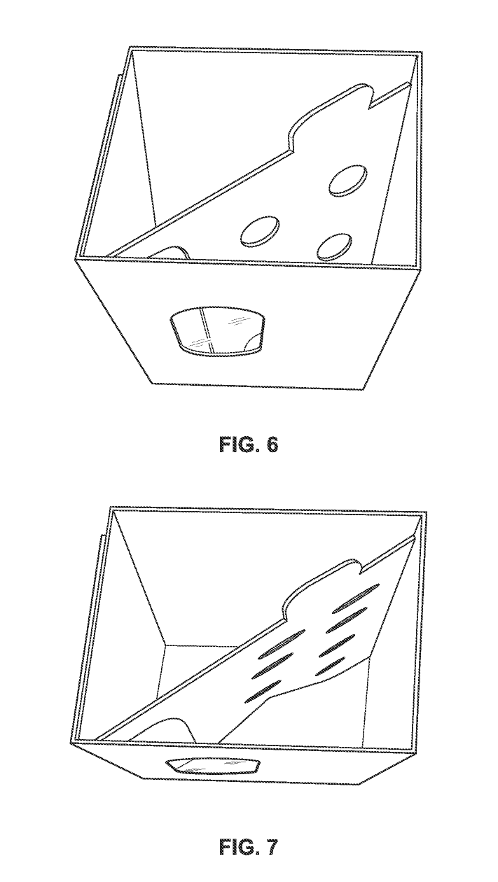

A partition panel 30 is connected to the other side of the bottom wall 26. The partition panel 30 is folded into the interior of the box when constructed. Preferably, the partition panel 30 extends across the interior of the box on a diagonal from one corner to an opposing corner (as shown in FIGS. 6 and 7), however other shapes or folds can be implemented in the partition panel.

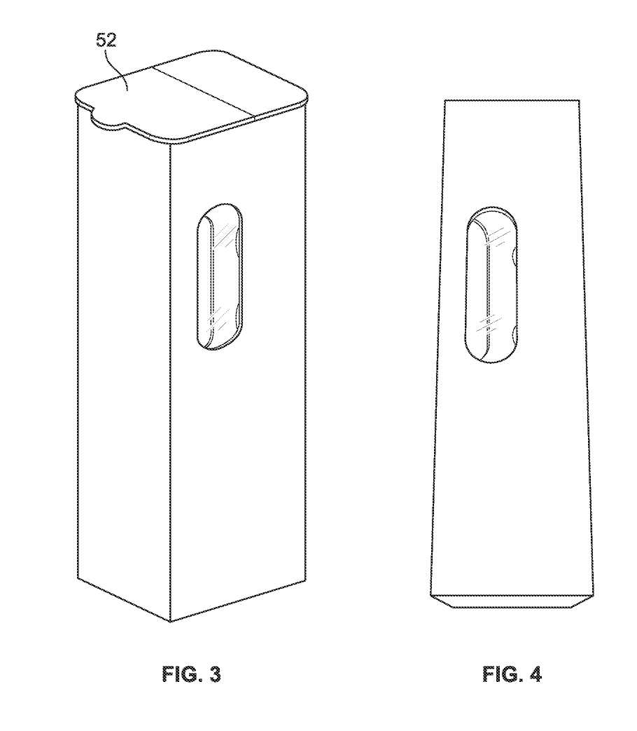

The partition panel 30 acts as a crawl space for the insects. The partition panel 30 includes a central arch or opening 32 positioned to generally correspond with the window 14. The partition panel 30 also includes perforations 34 and apertures or holes 36. These allow the crickets to climb around the partition panel 30. At one end, the partition panel 30 includes a projection 38. The projection 38 can be used to support a food product against a plastic cap (shown in FIG. 3) positioned at an end of the box. A V-shaped cut-out 40 provides an opening at the other end for allowing crickets to move from one side of the partition to the other.

Referring back to the first side wall 12, a glue panel 42 extends from a side of the first side wall 12 opposite the top panel 18. The glue panel 42 includes a layer of glue 44 which is adhered to the outside of the bottom wall 32 to form the box. The end flaps 16, 20, 24, 28 are folded in a conventional manner to close that end of the box. The end flaps 16, 20, 24, 28 can be glued or taped together to help prevent the insects from working their way out of the box from this end.

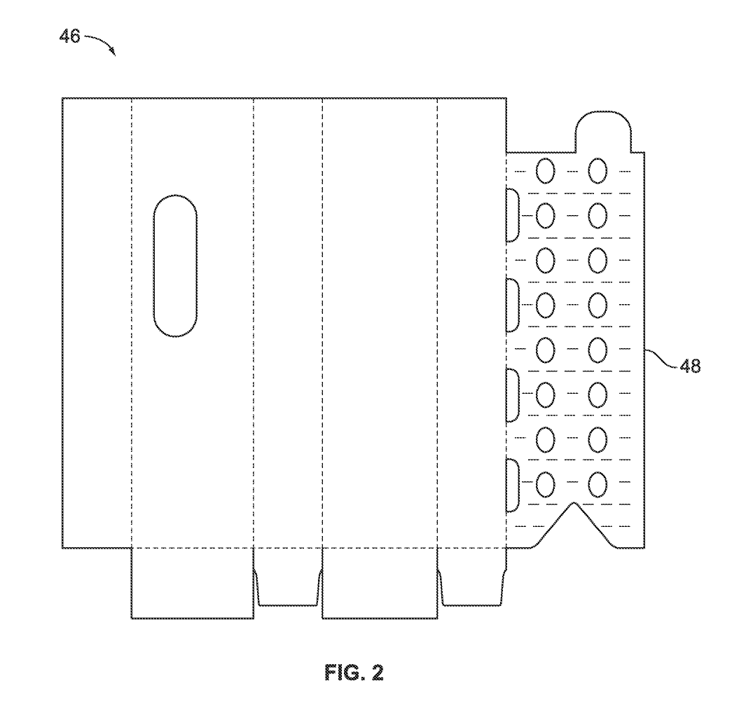

Referring to FIG. 2, a blank 46 is provided with a partition panel 48 with a different configuration than the panel 30 of FIG. 1. In both embodiments, the blank forms a box having an open end.

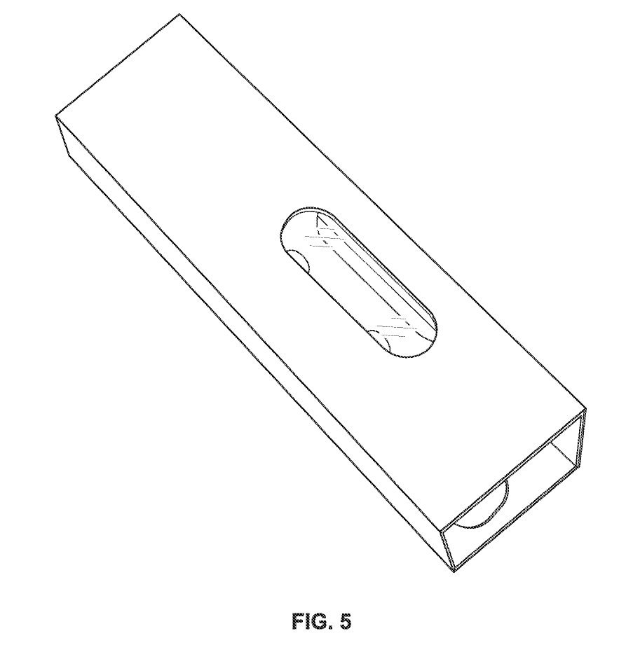

A constructed box 50 is shown in the photographs of FIGS. 3-7. In FIG. 3, a plastic end cap 52 is shown covering the open end of the box 50. The cap can be of any conventional or proprietary design. One preferred end cap 52 is shown in FIG. 9 and is discussed below.

FIGS. 3-5 all show the partition panel 30 through the window 14. Referring to the end views of FIGS. 6 and 7, the partition panel 30 is shown extending diagonally across the interior of the box.

The construction of the box allows air to get into the box through the folded end flaps such that additional air holes will likely not be required. The assembled and set up box is lightweight and less expensive to make than other similar insect containers. In particular, such other containers typically included metal screen dividers to partition portions of the interior. The metal screens were separate pieces that required extra time to assemble and were more expensive than the integrally formed board partition of the present invention.

The film used to cover the window 14 is preferably a polypropylene film that can be obtained from Interfilm Holdings, Inc. (see www.interfilm-usa.com). Specifically, the film is referred to as the Interfilm Type SPPF Micro-Perforated, Co-extruded, Slip treated film.

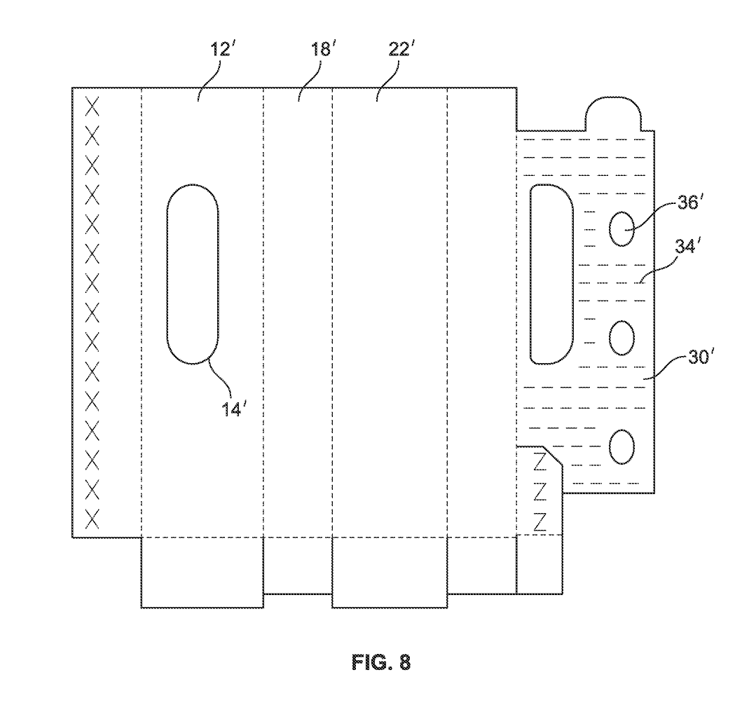

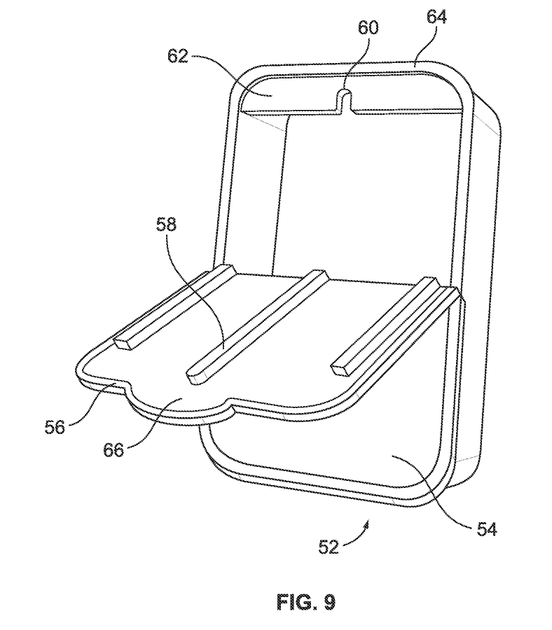

FIG. 8 shows another embodiment of the outside surface of a blank 10′ for forming the insect box of the present invention (like numbers, with a prime symbol, are used to show like features of the blank of FIG. 8 with the blank of FIG. 1). In this embodiment, the partition 30′ includes fewer holes 36′ than the other embodiments. Additionally, the window 14′ is larger than the other embodiments.

FIG. 9 shows a flip-top cap 52 for use with a constructed insect box 50. The cap 52 is formed from a suitable plastic material. The cap 52 includes a top panel 54 with an opening portion or panel 56 hingedly connected to the top panel 54 via a thinned region in the plastic. The opening portion 56 flips open to allow access to and from the box. A bar 58 or other similar feature formed in the inside surface of the opening portion 54 cooperates with a slot opening 60 in a projection 62 extending from an end 64 of the cap to snap fittingly close the cap 52. The opening portion 56 includes a lip 66 that projects past the end 64 to enable one to easily move the opening portion 54 up to open the cap 52.

While the specific embodiments have been illustrated and described, numerous modifications come to mind without significantly departing from the spirit of the invention and the scope of protection is only limited by the scope of the accompanying Claims.

I/we claim:

1. An easily assembled cricket box comprising:
a first side panel including a window having a film of one of transparent and translucent material glued across the window;
a second side panel;
a top panel connected to the first side panel and second side panel;
a bottom panel connected to the first side panel and second side panel; and,
an interior partition panel.

2. The cricket box of claim 1 wherein the partition panel includes a plurality of perforations and a plurality of holes.

3. The cricket box of claim 1 wherein the partition panel includes a projection for supporting a food product.

4. The cricket box of claim 1 wherein the partition panel includes an opening generally aligned with the window.

5. The cricket box of claim 1 further comprising a glue panel integrally connected to the first side panel, the glue panel including a layer of glue and being adhered to the bottom panel.

6. The cricket box of claim 5 wherein the first side panel, second side panel, top panel, bottom panel, partition panel and glue panel are formed from a single, foldable paperboard piece.

7. The cricket box of claim 6 wherein the first side panel is integrally connected to the top panel on one side and is integrally connected to the glue panel on a second side, and the bottom panel is integrally connected on one side to the partition panel.

8. The cricket box of claim 1 further comprising a flip-top plastic cap connected to an open end of the box.

9. A box for containing and transporting insects comprising:
a first side wall panel integrally connected to a top wall panel and a glue panel, the top wall panel integrally connected to a second side wall panel, the first side wall panel including a window; and,
a bottom wall panel integrally connected to the second side wall panel and integrally connected to a partition panel, wherein the glue panel is glued to at least a portion of the bottom wall panel and the partition panel is positioned in an interior of the box.

10. The box of claim 9 further comprising one of a transparent and translucent material covering the window on the first side wall.

11. The box of claim 9 wherein the first side wall panel, top wall panel, second side wall panel, bottom wall panel and partition panel are formed from a single sheet of paperboard.

12. The box of claim 9 wherein the first side wall panel, the top wall panel, the second side wall panel and the bottom panel each include a flap for forming an end closure at a first end of the box.

13. The box of claim 9 wherein the partition panel includes a plurality of perforations.

14. The box of claim 13 wherein the partition panel includes a plurality of holes.

15. The box of claim 9 wherein the partition panel includes a projection for supporting an insect food product.

16. The box of claim 9 wherein the partition panel includes an opening generally aligned with the window.

17. A box for containing a plurality of crickets comprising:
a paperboard sheet folded into a first side, a second side, a top side and a bottom side, wherein one of the first side, second side, top side and bottom side includes a window for viewing the contents of an interior of the box; and,
a paperboard partition panel positioned in the interior of the box to provide a crawlspace for crickets placed in the box.

18. The box of claim 17 wherein one of a transparent and translucent film is positioned across the window.

19. The box of claim 17 wherein the partition panel includes a plurality of perforations along a surface.

20. The box of claim 17 wherein the perforation panel supports a cricket food product.
